(19) United States
(12) Patent Application Publication
(10) Pub. No.: US 2002/0148405 A1
(43) Pub. Date: Oct. 17, 2002

(54) Electrostatic coater with power transmission frequency adjuster

(76) Inventor: Takuya Matsumoto, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/070,924

(22) PCT Filed: Jul. 17, 2001
(86) PCT No.: PCT/JP01/06175

(30) Foreign Application Priority Data
Jul. 21, 2000 (JP) 2000-219974

(51) Int. Cl. B05B 5/025

(52) U.S. Cl. 118/663; 118/621

(57) ABSTRACT

The present invention provides an electrostatic painting device with a transmission frequency adjustment device for automatically adjusting a transmission frequency in such a manner that a consumed current flowing in a high voltage booster circuit does not exceed a prescribed value. The present electrostatic painting device comprises a high-voltage booster circuit 201 provided in an electrostatic spray gun 2 to rectify a high frequency low voltage and generate a DC high voltage for electrostatic painting, a high-frequency low-voltage generator 1 provided independently of the electrostatic spray gun to generate a high frequency low voltage, a low-voltage cable 3 for connecting the high-frequency low-voltage to the high-voltage booster circuit, current sensor means 111 for detecting a current value corresponding to an intrinsic consumed current at the high-voltage booster circuit and frequency control means 107 and 112 for adjusting a frequency of a high frequency low voltage in such a manner that a current value detected by the current sensor means does not exceed a predetermined value.

### FIELD OF THE INVENTION

The present invention relates to an electrostatic coater (or painting device) and in particular to adjustment of frequency of a high-frequency low voltage supplied to an electrostatic painting device with a high-voltage booster circuit.

### BACKGROUND OF THE INVENTION

As is also disclosed in Japanese Patent Application Public-disclosure No. 10-128170, an internal booster-type electrostatic spray gun incorporating a high-voltage booster circuit has been developed as an electrostatic painting device. Such an electrostatic painting device, as is schematically described in FIG. 1, consists of a high-frequency low-voltage generator 1, an electrostatic spray gun (electrostatic painting device body) 2, a low-voltage cable 3, an air supplier (which is not shown) and a paint material supplier (which is not shown). A high-voltage booster circuit 201 comprises a transformer 202, a multiple voltage rectifier circuit 203, a resistor 204 and an output terminal 205. The high-frequency low-voltage generator 1 converts a voltage from a commercial alternating-current power supply to a DC voltage of 12V via a rectifier 101 and DC-DC converter 102. The thus obtained DC voltage is supplied to the intermediate point of the primary side coil of the transformer 202 via a line 103 and low-voltage cable 3. The ends of the primary side coil are connected to the collectors of transistors 104 and 105 respectively via the low-voltage cable 3 and their emitters are grounded by a common line 106. From an oscillation control circuit 107 to the bases of the transistors 104 and 105 are provided driving signals which are in 180-degree phase shift with each other, whereby the transistors 104 and 105 are turned on alternately at frequencies of the driving signals. The multiple voltage rectifier circuit 203, resistor 204 and output terminal 205 are connected to the secondary side coil of the transformer 202. The transformer 202 boosts the primary side voltage by dozens times, which is further boosted by the multiple voltage rectifier circuit 203 (by ten times in this example) to obtain a DC voltage of −40 kv˜−90 kv.

The high-voltage booster circuit incorporated in the internal booster-type spray gun has an intrinsic parallel resonance frequency (frequency at which a consumed current becomes minimum: hereafter referred to as an antiresonant frequency) attributable to its unique hardware structure, and when a voltage of such an antiresonant frequency is supplied to a high-voltage booster circuit, power can be converted to high voltages most efficiently. In other words, when a voltage of an antiresonant frequency is supplied, a current consumed at a high-voltage booster circuit is small, whereby a life of a transformer can be maximized while a load to be caused on the spray gun can be minimized. Further, as it is possible to generate a maximum voltage, efficient utilization of a voltage becomes viable.

FIG. 2 is a graph representing a change in current I consumed by a high-voltage booster circuit of an electrostatic spray gun when frequency f of an alternating-current low voltage sent from a high-frequency low-voltage generator to the high-voltage booster circuit is varied and a change in boosted negative DC voltage V. As can be seen from FIG. 2, the DC voltage V does not change much in the neighborhood of the antiresonant frequency whereas the current I changes significantly. In this example, when the device is driven at frequencies at which the consumed current I exceeds approximately 1A, the transformer is likely to be damaged by heat. Therefore, it is ideal that the device be driven at driving frequency f₀, at which the consumed current I becomes minimum, that is, about 0.2A.

Dispersion arising during the manufacture of high voltage booster circuits, for example, dispersion in electronic components of circuits sometimes results in disadvantageous fluctuation of an intrinsic antiresonant frequency of a high-voltage booster circuit. Further, when voltage supply from a high-frequency low voltage generator shifts from a high-voltage booster circuit for generating a voltage of, for example, −40 kv to a high-voltage booster circuit for generating a voltage of, for example, −90 kv, an optimum transmission frequency cannot be specified. Still further, when a technical specification of a high-voltage booster circuit per se is changed, for example, a transformer thereof is improved or modified with a view to cost reduction, etc., an antiresonant frequency specific to the high-voltage booster circuit also changes.

If a high frequency low voltage whose frequency does not coincide with an antiresonant frequency specific to a high voltage booster circuit is supplied to the high voltage booster circuit, an excess current flows into a transformer of the high voltage booster circuit to cause failure and a rated output is not generated. Therefore, when an intrinsic antiresonant frequency fluctuates beyond the referential scope as a result of dispersion arising during manufacture of a high-voltage booster circuit, an electrostatic spray gun incorporating the high-voltage booster circuit is considered to be defective and thus, productivity substantially declines.

On the other hand, a volume for adjusting a frequency may be attached to the oscillation control circuit 107 of the high frequency low voltage generator 1 indicated in FIG. 1 to initialize an oscillation frequency at the time of assembly of the high frequency low voltage generator 1. For example, a transmission frequency is set to be about fₓ in the case of a high voltage booster circuit cartridge for −60 kv (natural antiresonant frequency=fₓ), whereas a transmission frequency is set to be about f_{y} in the case of a high voltage booster circuit cartridge for −40 kv (natural antiresonant frequency=fy). When antiresonant frequencies specific to high voltage booster circuits disperse, an ammeter is connected to the line 103 of the high frequency low voltage generator 1 and a volume is adjusted by monitoring a current value read by the ammeter to set, as an intrinsic antiresonant frequency, a frequency at which the current value becomes minimum. However, initialization or resetting of a frequency while monitoring an ammeter can be troublesome.

Given the aforementioned problems of prior art, it is an object of the present invention to provide an electrostatic painting device with a transmission frequency adjustment device which can automatically adjust a transmission frequency such that a consumed current running in the high voltage booster circuit does not exceed a certain value.

### SUMMARY OF THE INVENTION

An electrostatic painting device provided with a transmission frequency adjustment device of the present invention comprises a high voltage booster circuit provided inside the body of the electrostatic painting device to rectify a high frequency low voltage and generate a DC high voltage for electrostatic painting, a high frequency low voltage generator provided independently of the body of the electrostatic painting device to generate a high frequency low voltage, a low voltage cable connecting the high frequency low voltage generator to the high voltage booster circuit, current sensor means for detecting a current value corresponding to a value of an intrinsic consumed current at the high voltage booster circuit and frequency control means for adjusting a frequency of a high frequency low voltage such that a value of a current detected by the current sensor means does not exceed a certain value.

According to an embodiment of the present invention, the frequency control means exercises control for determining a driving frequency to the high voltage booster circuit such that a value of a current detected by the current sensor means becomes a minimum value. The current sensor means is installed in the high frequency low voltage generator to detect a current guided to the low voltage cable. The frequency control means can operate either when a power switch of the electrostatic painting device is closed or at the set times. The electrostatic painting device is further provided with an abnormality indication means for indicating abnormality when a value of a current detected by the current sensor means exceeds a predetermined value. The frequency control means adjusts a frequency of a high frequency low voltage when abnormality is indicated.

### BRIEF DESCRIPTION OF THE DRAWINGS

FIG. 1 is a schematic system diagram of a conventional electrostatic painting device.

FIG. 2 is a graph representing a change in a relationship between a frequency and a consumed current and a change in a relationship between a frequency and a generated DC voltage.

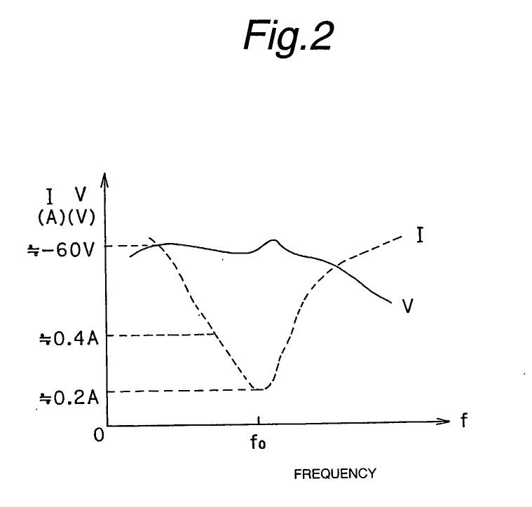

FIG. 3 is a schematic system diagram indicating an embodiment of an electrostatic painting device provided with a transmission frequency adjustment device of the present invention.

FIG. 4 is a flow chart depicting an embodiment of a transmission frequency adjusting operation of the present invention.

FIG. 5 is a graph representing a mode of an operation for searching an optimum driving frequency depicted in FIG. 4.

### PREFERRED EMBODIMENT OF THE PRESENT INVENTION

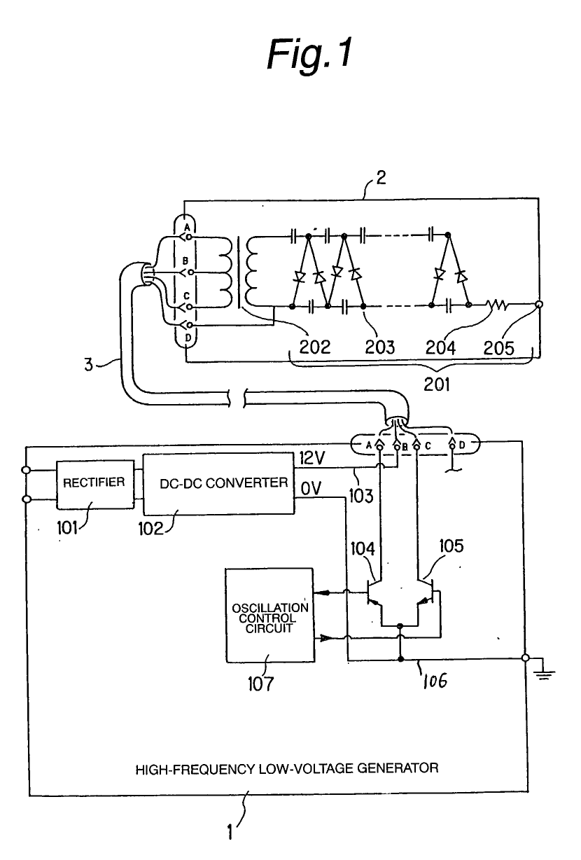

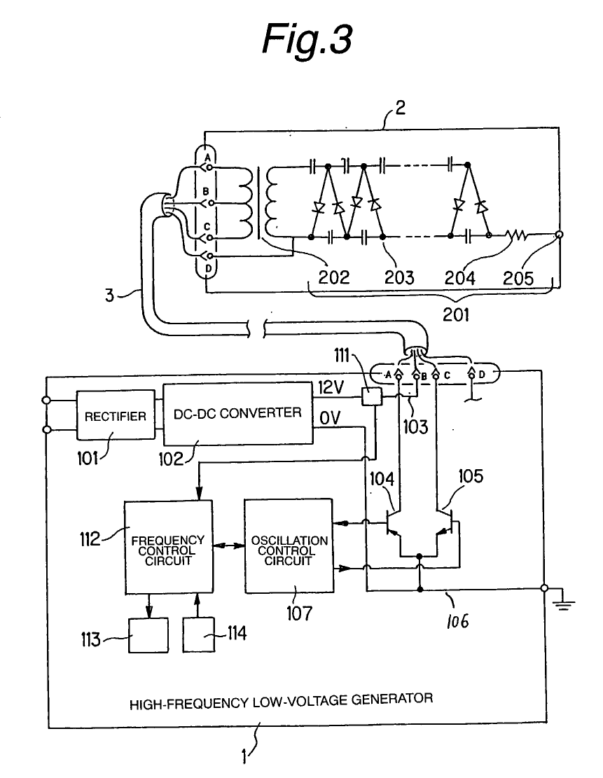

FIG. 3 is a schematic system diagram indicating an electrostatic painting device provided with a transmission frequency adjustment device of the present invention. In FIGS. 1 and 3, like numerals denote like components. In the high frequency low voltage generator 1 in FIG. 3, the current detection sensor 11 is connected to the line 103 applying a 12V output from the DC-DC converter 102 to the low voltage cable 3. The current detection sensor 11 may be a search coil, etc., and anything can be used as the current detection sensor 11 in so far as it can detect a value proportional to a value of a current flowing in the line 103. A current flowing in the line 103 is a current on the primary side of the transformer 202 of the high voltage booster circuit 201 and corresponds to a current consumed by the high voltage booster circuit 201. A value of a current detected by the current detection sensor 111 is converted to a digital signal by an A/D (analog/digital) converter to be output to the frequency control circuit 112. The frequency control circuit 112 stores a frequency adjusting program, in accordance with which a signal of an input current value is processed. If it transpires that the thus processed signal exceeds a threshold, a warning indication signal is output to warning indication means 113. In response to an output of the warning indication signal, the warning indication means 113 turns on a warning lamp and/or sounds alarm. The frequency control circuit 112 adjusts an increase/decrease in an oscillation frequency of the oscillation control circuit 107 in accordance with the frequency adjusting program. Further, the search start button 114 is connected to the frequency control circuit 112, and when the search start button 114 is operated, a predetermined sub-routine of the frequency adjusting program starts to perform an operation for searching an optimum driving frequency.

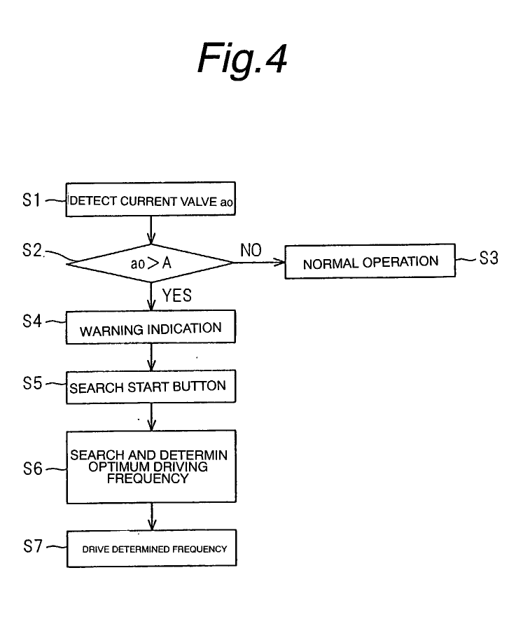

FIG. 4 is a flow chart depicting a processing operation performed in accordance with the frequency adjusting program stored in the frequency control circuit 112. At step S1, the frequency control circuit 112 receives a current value a₀ detected by the current detection sensor 111. Next, at step S2, the current value a₀ is compared with a threshold A representing a safe driving boundary of the frequency. If the current value a₀ is less than the threshold A, it is determined that the current oscillation frequency of the oscillation control circuit 107 is adequate and the processing operation proceeds to step S3, where the high voltage booster circuit 201 is driven at the current oscillation frequency to operate the electrostatic spray gun. On the other hand, if it transpires at step S2 that the current value a₀ has exceeded the threshold A, the processing operation proceeds to step S4, where the oscillation control circuit 107 outputs a warning signal to the warning indication means 113 to indicate warning. Next, the processing operation proceeds to step S5, where an operator finds abnormality of a driving frequency from the warning indication and presses the search start button 114 to output a search start signal to the frequency control circuit 112. The processing operation further proceeds to step S6, where a frequency adjusting program receives a search start signal and starts an operation for searching an optimum driving frequency.

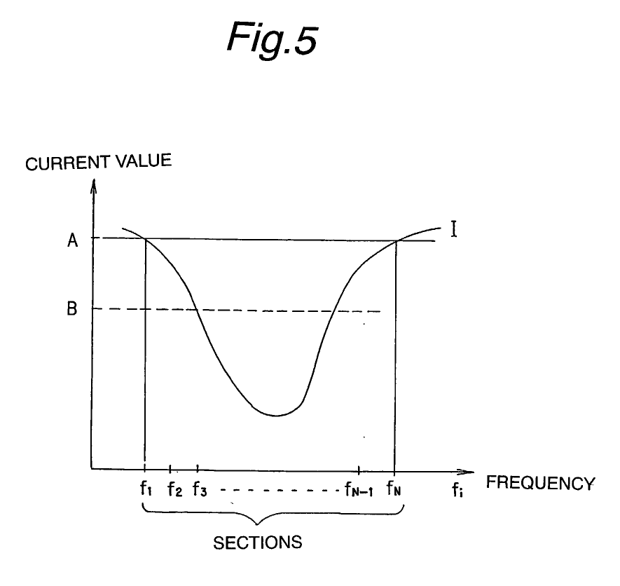

The operation for searching an optimum driving frequency is performed at step S6 as follows. As is indicated in FIG. 5, a frequency band within the range of search is divided into a plurality of sections (N sections in this example) to obtain a plurality of driving frequencies fi (i=1, 2, 3 . . . N; f₁<f₂), and the high voltage booster circuit 201 is driven successively at the thus obtained different driving frequencies to find current values aᵢ(i=1, 2, 3 . . . N) corresponding to the respective driving frequencies fi and store the same. Next, the smallest one of the stored current values aᵢ is selected and the driving frequency fi corresponding to the thus selected smallest current value aᵢ is determined to be an optimum driving frequency. The processing operation then proceeds to step S7, where the high voltage booster circuit 201 is driven at the thus chosen optimum driving frequency fi to operate the electrostatic spray gun.

The above embodiment employs a manner for obtaining detected current values corresponding to a plurality of driving frequencies to determine an optimum driving frequency. However, the present invention is not limited to the above manner and other known methods for determining an optimum driving frequency such as a method for estimating an optimum driving frequency from a driving frequency-consumed current characteristic curve, at which a current value becomes the smallest, etc. may be employed. Further, although in the above embodiment a driving frequency at which a current value becomes the smallest is determined, frequencies corresponding to detected current values not more than a predetermined value, for example, a threshold B (B=0.6× the aforementioned threshold A) may be determined to be driving frequencies.

Still further, a processing operation in accordance with the frequency adjusting program may be performed when a power switch of the high-frequency low-voltage generator 1 is closed or at the times pre-set by the oscillation control circuit 107 or when the high voltage booster circuit 201 is exchanged, modified, etc.

An electrostatic painting device of the present invention is designed such that an optimum frequency at which a minimum consumed current value specific to a high-voltage booster circuit incorporated in the electrostatic painting device or permissible consumed current value is obtained can be automatically generated at a high-frequency low-voltage generator. Therefore, frequencies affected by dispersion arising during manufacture of high voltage booster circuits can be easily adjusted to be an optimum frequency to compensate for manufacturing dispersion. Further, if a new spray gun provided with a high voltage booster circuit of a different voltage specification is employed at a job site, the same high frequency low voltage generator as used for the old spray gun can be employed as it is to readily adjust a frequency of the high voltage booster circuit of the new spray gun to an optimum frequency. Thus, an electrostatic painting device of the present invention is always driven at an optimum frequency, which prolongs a life of the apparatus and improves quality of products manufactured by the apparatus.

In the present invention, an electrostatic spray gun for atomizing a painting material by compressed air and charging particles of the material is described as an embodiment of an optimum electrostatic painting device. However, the present invention is in no way restricted by the above embodiment and is applicable to, for example, an electrostatic rotary atomization type painting device for discharging a painting material in the form of a thin film from the rim of a cup rotating at a high speed by means of a centrifugal force of the cup and atomizing the material in the form of a thin film by means of repulsion of static electricity instead of utilizing compressed air.

The embodiment described above is given as an illustrative example only. It will be readily appreciated that many deviations may be made from the specific embodiment disclosed in the specification without departing from the invention. Accordingly, the scope of the invention is to be determined by the claims.

1. An electrostatic painting device with a transmission frequency adjustment device, comprising:
high-voltage booster circuit provided inside the body of the electrostatic painting device to rectify a high-frequency low-voltage and generate a DC high voltage for electrostatic painting;
high-frequency low-voltage generator provided independently of said electrostatic painting device to generate said high-frequency low-voltage;
a low-voltage cable connecting said high-frequency low-voltage generator to said high-voltage booster circuit;
current sensor means for detecting a current value corresponding to an intrinsic consumed current at said high-voltage booster circuit;
frequency control means for adjusting a frequency of said high-frequency low-voltage in such a manner that a current value detected by said current sensor means does not exceed a prescribed value.

2. The electrostatic painting device as defined in claim 1, wherein said frequency control means exercises control to determine a frequency of said high-frequency low-voltage in such a manner that a current value detected by said current sensor means becomes the smallest.

3. The electrostatic painting device as defined in claim 1 or 2, wherein said current sensor means is provided in said high-frequency low-voltage generator to detect a current supplied to said low-voltage cable.

4. The electrostatic painting device as defined in claim 1 or 2, wherein said frequency control means performs an operation for adjusting a frequency of said high-frequency low-voltage when the power switch of the electrostatic painting device is closed.

5. The electrostatic painting device as defined in claim 1 or 2, wherein said frequency control means performs an operation for adjusting a frequency of said high-frequency low-voltage at the set times.

6. The electrostatic painting device as defined in one of claims 1-5, further comprising an abnormality indication means for indicating an abnormal state when a current value detected by said current sensor means exceeds a predetermined value, said frequency control means performing an operation for adjusting a frequency of said high-frequency low-voltage when an abnormal state is indicated.
